(19) United States
(12) Patent Application Publication
(10) Pub. No.: US 2014/0229328 A1
(43) Pub. Date: Aug. 14, 2014

(54) System and Method of Presenting and Monetizing Visual Images

(71) Applicants: Andrew Butler, Palo Alto, CA (US); Larry Tsai, Hong Kong (HK); Bill Burnett, Menlo Park, CA (US); Xiao Li, Sunnyvale, CA (US); Jon Logan, San Francisco, CA (US); Art Wagner, Berkeley, CA (US)

(72) Inventors: Andrew Butler, Palo Alto, CA (US); Larry Tsai, Hong Kong (HK); Bill Burnett, Menlo Park, CA (US); Xiao Li, Sunnyvale, CA (US); Jon Logan, San Francisco, CA (US); Art Wagner, Berkeley, CA (US)

(21) Appl. No.: 14/161,604

(22) Filed: Jan. 22, 2014

Related U.S. Application Data
(60) Provisional application No. 61/755,400, filed on Jan. 22, 2013.

(51) Int. Cl. G06Q 30/06; G06Q 30/02; G06F 3/048; G06Q 10/02

(52) U.S. Cl. CPC G06Q 30/0633; G06Q 10/02; G06Q 30/0251; G06F 3/048
USPC 705/26.8; 705/5; 705/14.49; 345/173

(57) ABSTRACT

A device and method for displaying and monetizing photo and video images shared on social media services, comprising a display means and a user interface that enables the user to display photo streams from social media services such as Facebook or Instagram, “like” photos shown on the screen, and purchase items or services associated with the photo or video being displayed. The device preferably offers a simple hardware button for “liking” a photo.

### CROSS-REFERENCE TO RELATED APPLICATIONS

The present application is related to and takes priority from U.S. Provisional Application No. 61/755,400, filed Jan. 22, 2013, which is hereby incorporated in the present application by reference.

### BACKGROUND

1. Field of the Invention

The present invention generally relates to social media, and more specifically relates to a system and method for monetizing shared visual images.

2. Description of Related Art

Social media has become an increasingly popular way of sharing photos, videos, and other graphical material. Services such as Instagram, Facebook Photos, or Twitpics, are used by users around the world to share and view their images and videos.

Users of these services may very well want to purchase high-quality prints of the photos they especially like, or to order objects such as calendars or T-shirts with the images printed on them. Also, a user viewing a photo of, say, a restaurant or a hotel, may be inspired to reserve a table at the restaurant or book a vacation at the hotel. A user viewing a photo of a product may be inspired to order the product online. A seamless way of integrating photo display and purchasing is needed.

### SUMMARY OF THE INVENTION

An object of the present invention is to integrate photo display and purchasing in a way that would make it easy for a user to order a product or service displayed in a photo.

Another object of the present invention is to enable a user to “like” a photo on a social media service by means of a hardware button on a photo display device.

In its preferred embodiment, the present invention comprises a photo display device, comprising a screen, a user interface, and an Internet connection module, which displays photos either as an automatic slideshow or statically, and which can connect to an online photo source such as Instagram or Facebook to receive photos for display. The present invention also, preferably, comprises a hardware button that enables a user to “like” a photo on a social media service such as Instagram or Facebook. “Liked” photos, in an embodiment, are stored in the device's memory.

In an embodiment, the device receives photos as well as information about each photo from the online photo source. Such information may be information about who took the photo, where it was taken, when it was taken, who or what is displayed in the photo, and so on. A user may access information about a displayed photo by swiping their finger across the touchscreen, or by performing another action on the user interface.

In an embodiment, the device is able to connect to online shopping services such as Amazon, eBay, Travelocity, airline websites, hotel websites, and other websites that offer products or services for sale, and to enable a user to purchase a product or service relating to the subject matter in the photo. Such products or services may be airline tickets or hotel reservations at a place shown in a photo, restaurant reservations at a restaurant shown in a photo (or a plate of food shown in a photo), or shopping websites to enable a user to purchase a product shown in a photo.

In an embodiment, the device comprises a GPS module that enables it to offer targeted advertising or to customize its display of photos based on location.

In an embodiment, the device learns the user's preferences and over time, preferentially displays the photos that the user is more likely to enjoy.

### BRIEF DESCRIPTION OF THE DRAWINGS

FIG. 1 shows a view of the preferred embodiment of the present invention.

### DETAILED DESCRIPTION OF THE PREFERRED EMBODIMENT

The object of the present invention is to provide a system and method for displaying visual images and enabling the monetization of said visual images. The embodiment described below is solely an example, and should not be construed to limit the invention.

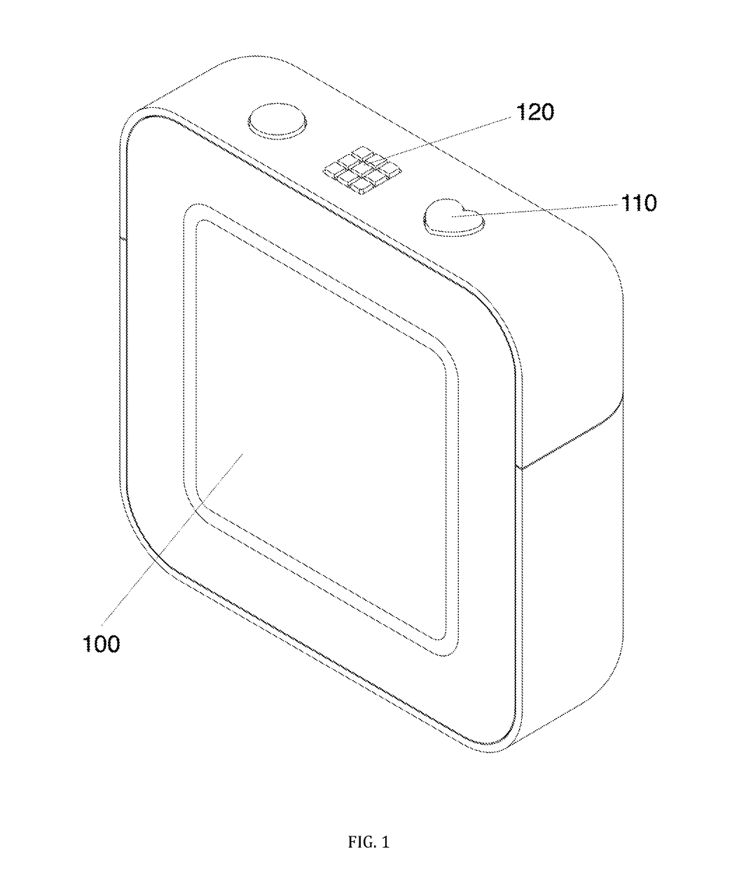

The system of the preferred embodiment of the present invention, as shown in FIG. 1, comprises a photo display module, which comprises a screen 100, a user interface 110 and 120, and a wireless interface for connecting to the Internet (not shown). The photo display module can also comprise an audio output device such as a speaker, and may be capable of displaying videos. In an embodiment, the photo display module can also comprise an internal memory. The user interface may be a touchscreen, hardware buttons, another device that wirelessly connects to the photo display module, a plug-in keyboard or touchpad, a remote control, or any other user interface means known in the art. In the preferred embodiment, the user interface comprises a touchscreen and at least one hardware button.

In the preferred embodiment, photos are displayed on the screen of the photo display module. The photos may come from an Instagram photo stream, Facebook Photos, Twitpics, Google Images, or any other online photo display or social media service. The user may select a particular hashtag, a particular user, a particular subject matter (i.e. cute kittens), “liked” photos, or any other selections that can be made on the given online photo display or social media service to customize the photo stream. The photos may be automatically streamed in a slideshow mode, or may be displayed statically until the user advances manually to the next photo. The device may also be capable of displaying several images in “thumbnail” mode to enable the user to select a particular photo to display.

Many social media services such as Facebook or Instagram offer the user the ability to “like” a photo or video. In the preferred embodiment, the photo display module has a hardware “like” button 120 that enables the user to “like” a photo displayed on the screen. If a user sees a photo they like, the user presses the “like” button. This automatically transmits the “like” data to the social media service where the photo came from (i.e. Facebook or Instagram). In the preferred embodiment, the action of pressing the “like” button also causes the photo display module to cache the photo in its internal memory. The advantage of a hardware button is that it does not take up any screen real estate and that its function can be made immediately apparent to the user by its shape. For example, the “like” button may be shaped like a heart or a thumbs-up hand. While the preferred embodiment comprises a hardware button on the photo display module to enable the user to “like” a photo or video, the same function may also be achieved by a particular touchscreen gesture, a sound (for example, the user may say “I like this!” and the user interface may interpret it as a “like” function), or a button on the remote control associated with the device.

A user may wish to purchase a high-quality print of the photo or to purchase various items with the photo printed on them. In the preferred embodiment of the invention, the user performs a swiping gesture across the screen to “flip” the photo. Each photo is visualized as either a double-sided or a many-sided object; the front side of the object is the photo itself, and other sides of the object display information such as who took the photo, any text associated with the photo, and links to enable the user to purchase prints or other items.

A user may also wish to purchase the item in the photo, to reserve a table at a restaurant that prepared a meal pictured in the photo, to book an airplane trip to the place shown in the photo, or to book a hotel at the place shown in the photo. In the preferred embodiment of the invention, the user performs a swiping gesture across the screen to “flip” the photo. As discussed above, each photo is visualized as a double-sided or many-sided object; one of the sides of the object shows purchase information for the item or service shown in the photo, and the user may use the user interface of the photo display module to purchase the item or service.

The photo display module may offer targeted advertising to the user. The advertising may be offered automatically at intervals—for example, every 10th picture can be an ad—or can be offered at particular times of day. The photo display module may also comprise a means of determining its location to make the targeted advertising more relevant.

For example, the photo display module may start displaying pictures of delicious food from nearby restaurants shortly before lunchtime. When the user sees a picture they like, they can “flip” the photo to access OpenTable or SeamlessWeb to reserve a table at the restaurant or to order the pictured meal for delivery to their desk.

The photo display module may be used as a “personal concierge” in a hotel. The services offered by the hotel, or nearby attractions, may be displayed on the screen of the photo display module. For example, the user can select an image of a nearby tourist attraction, “flip” the photo to access the reservation service, and reserve tickets for the tourist attraction.

The photo display module may be linked to online stores such as Amazon or eBay. A user can see a picture showing a product they like, whether as targeted advertising or as a simple user-generated photo, and “flip” the photo to access purchase information for the product. The user may then purchase the product.

The photo display module may also be linked to news media sites such as online newspapers or magazines. For example, the user may see a photo of an event they want to learn more about. The user can then “flip” the photo and find a link to an article about the event; they can then get the article displayed on the screen, emailed to their email address, or delivered to them by any other means known in the art. The news media site may offer the article at no cost or may charge the user for this service.

The links (whether to online shopping, airline reservations, news media, or anything else) may be automatically created by the photo display module, may be created by an online search engine such as Google, may be inferred from GPS data included in the photo, or may be manually created by the users who upload the pictures. For example, a user may mention a particular restaurant name in the metadata for the picture of a meal, or the photo display module may use the GPS data to detect what restaurant the picture of the meal originated from. In case of a picture of a location, the links to hotel and airline reservations to that location may be automatically created by the photo display module, using the GPS data or the name of the place listed in the metadata.

In the preferred embodiment, the purchase function is accomplished by a dedicated hardware button on the device. This simplifies the user interface and avoids taking up screen real estate. The hardware button may be shaped like a shopping cart to make its function especially obvious. However, in alternate embodiments, the purchase function may be accomplished by clicking a link on the touchscreen, a specialized touchscreen gesture, voice control (“I want to buy this!”), a remote control button, or any other interface means.

The photo display module may learn the user's preferences or tastes by analyzing what hashtags the user selects, what photos the user “likes”, or what photos the user spends more time looking at. The photo display module may then suggest other hashtags that the user may enjoy, or preferentially display photos that are similar to the ones the user enjoys the most. This may be accomplished by analyzing hashtags and other metadata, or by analyzing the image directly.

For example, if the user has selected the “puppies” hashtag to display a photostream of puppies, and spends more time looking at Doberman puppies than other breeds of puppies, the photo display module may also suggest the “Doberman” hashtag, or may preferentially display Doberman puppies in the photostream (either by omitting other photos or by displaying Doberman puppy pictures for a longer time than other puppy pictures). The photo display module may also use the user preference data it has compiled to offer targeted advertising to the user (for example, ads for dog food or pet-sitting services).

While services such as Instagram or Facebook are free, paid content may also be offered. For example, in some embodiments, the user may select a “premium” photo stream or live webcam feed to be displayed on the photo display module, and be charged for it automatically.

1. A photo display module, comprising:
a screen;
a processor and memory;
a wireless communication interface enabling the photo display module to connect to the Internet and to display photos from at least one online source;
a user interface comprising a touchscreen and at least one hardware button.

2. The photo display module of claim 1, further comprising means for a user to “like” a photo on a social media service.

3. The photo display module of claim 1, where at least one hardware button enables a user to “like” a photo on a social media service.

4. The photo display module of claim 3, where the at least one hardware button also caches the “liked” photo in the memory of the photo display module.

5. The photo display module of claim 1, where the at least one hardware button is shaped like one of the following: a thumbs-up hand, a heart.

6. The photo display module of claim 1, where the at least one online source is Instagram.

7. The photo display module of claim 1, where the at least one online source is Facebook.

8. The photo display module of claim 1, where the user interface allows the user to filter the photos displayed on the photo display module by one or more of the following filters: hashtag, subject matter, user.

9. The photo display module of claim 1, where the user can use the user interface to purchase an item or service displayed in a photo.

10. The photo display module of claim 1, where the user can use the user interface to book an airplane flight to a place shown in a photo.

11. The photo display module of claim 1, where the user can use the user interface to reserve a hotel room at a place shown in a photo.

12. The photo display module of claim 1, further comprising a button that, when pressed, enables a user to purchase a product or service related to a photo.

13. The photo display module of claim 1, where the photo display module displays targeted advertising.

14. The photo display module of claim 1, further comprising a GPS module.

15. The photo display module of claim 1, where the user can use the user interface to access newspaper articles about the subject matter shown in a photo.

16. The photo display module of claim 1, where the photo display module analyzes the subject matter of the photos “liked” by the user and preferentially displays photos with that subject matter.

17. The photo display module of claim 1, further comprising a module for accepting payment for displaying photos.

18. A method of displaying photos, comprising:
using a photo display module to receive a photo from an online source;
using the photo display module to receive information about the photo from the online source;
displaying the photo on the photo display module;
if a user performs an action, displaying background information about the photo;
if a user performs an action, displaying a purchase page to enable the user to purchase an item or service shown in the photo;
if a user performs an action, displaying a purchase page to enable the user to reserve a flight to a location shown in the photo;
if a user performs an action, displaying a purchase page to enable the user to reserve a hotel at a location shown in the photo;
if a user performs an action, displaying newspaper articles about the subject matter of the photo.

19. The method of claim 18, where the action performed by the user is one or more of the following group: pressing a hardware button, touching a touchscreen, speaking into a microphone.

20. The method of claim 18, where the photos that are received from an online source are customized by one or more of the following: location, subject matter, hashtag, user.

21. The method of claim 18, where the purchase page is linked to the photo automatically.

22. The method of claim 18, where the purchase page is linked to the photo manually by a user who uploaded the photo.

23. The method of claim 18, where the purchase page is linked to the photo by means of embedded GPS information in the photo.
